(19) United States
(12) Patent Application Publication
(10) Pub. No.: US 2025/0200955 A1
(43) Pub. Date: Jun. 19, 2025

(54) MODEL TRAINING METHOD AND APPARATUS, DEVICE, STORAGE MEDIUM, AND PRODUCT

(71) Applicant: TENCENT TECHNOLOGY (SHENZHEN) COMPANY LIMITED, Shenzhen (CN)

(72) Inventors: Yatai JI, Shenzhen (CN); Rongcheng Tu, Shenzhen (CN); Weijie Kong, Shenzhen (CN); Jie Jiang, Shenzhen (CN); Chengfei Cai, Shenzhen (CN); Wenzhe Zhao, Shenzhen (CN); Hongfa Wang, Shenzhen (CN); Wei Liu, Shenzhen (CN)

(73) Assignee: TENCENT TECHNOLOGY (SHENZHEN) COMPANY LIMITED, Shenzhen (CN)

(21) Appl. No.: 19/070,901

(22) Filed: Mar. 5, 2025

Related U.S. Application Data
(63) Continuation of application No. PCT/CN2023/130147, filed on Nov. 7, 2023.

(30) Foreign Application Priority Data
Feb. 22, 2023 (CN) 202310181561.5

(51) Int. Cl. G06V 10/778; G06F 40/284; G06V 10/42; G06V 10/74; G06V 10/77; G06V 10/776

(52) U.S. Cl. CPC G06V 10/778; G06F 40/284; G06V 10/42; G06V 10/761; G06V 10/7715; G06V 10/776

(57) ABSTRACT

A model training method includes obtaining first and second modal data sets including pieces of data, wherein the pieces of data include sub-modal data pieces, and wherein pieces of the first modal data correspond to pieces of the second modal data; obtaining masked data sets by masking a piece of the first and second sub-modal data, respectively; performing feature prediction on the first masked data set and the second modal data set and the second masked data set and the first modal data set, based on ta feature extraction model, to obtain first and second global features and first and second global recovery features; and generating a trained feature extraction model by optimizing the feature extraction model based on the first global recovery features, the first global features, the second global recovery features, and the second global features.

### CROSS-REFERENCE TO RELATED APPLICATIONS

This application is a continuation application of International Application No. PCT/CN2023/130147 filed on Nov. 7, 2023, which claims priority to Chinese Patent Application No. 202310181561.5 filed with the China National Intellectual Property Administration on Feb. 22, 2023, the disclosures of each being incorporated by reference herein in their entireties.

### FIELD

The disclosure relates to the field of computer technologies, and to a model training method, a model training apparatus, a computer device, a computer-readable storage medium, and a computer program product.

### BACKGROUND

With the advancement of scientific and technological research, massive amounts of data have emerged from the Internet. Types of the data may include, but are not limited to, text, images, videos, and the like. Data including a plurality of (at least two) different types may be referred to as multi-modal data. A semantic correlation between the multi-modal data is involved in many fields, such as a field of matching picture for text, a field of writing according to picture, and a field of advertisement push. It has been found through research that a mainstream manner of determining the semantic correlation between the multi-modal data is extracting a feature of the multi-modal data by using a feature extraction model, and predicting the semantic correlation between the multi-modal data based on the feature of the multi-modal data. How to improve accuracy of a prediction result of the feature extraction model has become a hot issue in current research.

### SUMMARY

According to an aspect of the disclosure, a model training method, performed by a model training apparatus includes, obtaining a first modal data set and a second modal data set, wherein the first modal data set includes a plurality of first modal data pieces, and a first piece of the plurality of first modal data pieces include a plurality of first sub-modal data pieces, wherein the second modal data set includes a plurality of second modal data pieces, and a second piece of the plurality of second modal data pieces include a plurality of second sub-modal data pieces, and wherein the plurality of first modal data pieces correspond to the plurality of second modal data pieces; obtaining a first masked data set by masking at least one third piece of the plurality of first sub-modal data pieces, and obtaining a second masked data set, by masking at least one fourth piece of the plurality of second sub-modal data pieces; performing feature prediction on the first masked data set and the second modal data set based on a feature extraction model, to obtain a plurality of first global recovery features of the plurality of first modal data pieces and a plurality of second global features of the plurality of second modal data pieces; performing feature prediction on the second masked data set and the first modal data set based on the feature extraction model, to obtain a plurality of first global features of the plurality of first modal data pieces and a plurality of second global recovery features of the plurality of second modal data pieces; and generating a trained feature extraction model for retrieving corresponding first modal data and second modal data by optimizing the feature extraction model based on the plurality of first global recovery features, the plurality of first global features, the plurality of second global recovery features, and the plurality of second global features.

According to an aspect of the disclosure, a model training apparatus includes, at least one memory configured to store computer program code; and at least one processor configured to read the program code and operate as instructed by the program code, the program code including first obtaining code configured to cause at least one of the at least one processor to obtain a first modal data set and a second modal data set, wherein the first modal data set includes a plurality of first modal data pieces, and a first piece of the plurality of first modal data pieces include a plurality of first sub-modal data pieces, wherein the second modal data set includes a plurality of second modal data pieces, and a second piece of the plurality of second modal data pieces include a plurality of second sub-modal data pieces, and wherein the plurality of first modal data pieces correspond to the plurality of second modal data pieces; and second obtaining code configured to cause at least one of the at least one processor to obtain a first masked data set by masking at least one third piece of the plurality of first sub-modal data pieces, and obtain a second masked data set by masking at least one fourth piece of the plurality of second sub-modal data pieces; and feature prediction code configured to cause at least one of the at least one processor to perform feature prediction on the first masked data set and the second modal data set based on a feature extraction model, to obtain a plurality of first global recovery features of the plurality of first modal data pieces and a plurality of second global features of the plurality of second modal data pieces; perform feature prediction on the second masked data set and the first modal data set based on the feature extraction model, to obtain a plurality of first global features of the plurality of first modal data pieces and a plurality of second global recovery features of the plurality of second modal data pieces; and optimization code configured to cause at least one of the at least one processor to generate a trained feature extraction model for retrieving corresponding first modal data and second modal data by optimizing the feature extraction model based on the plurality of first global recovery features, the plurality of first global features, the plurality of first global recovery features, and the plurality of second global features.

According to an aspect of the disclosure, a non-transitory computer-readable storage medium, storing computer code which, when executed by at least one processor, causes the at least one processor to at least obtain a first modal data set and a second modal data set, wherein the first modal data set includes a plurality of first modal data pieces, and a first piece of the plurality of first modal data pieces include a plurality of first sub-modal data pieces, wherein the second modal data set includes a plurality of second modal data pieces, and a second piece of the plurality of second modal data pieces include a plurality of second sub-modal data pieces, and wherein the plurality of first modal data pieces correspond to the plurality of second modal data pieces; and obtain a first masked data set by masking at least one third piece of the plurality of first sub-modal data pieces, and obtain a second masked data set by masking at least one fourth piece of the plurality of second sub-modal data pieces; and perform feature prediction on the first masked data set and the second modal data set based on a feature extraction model, to obtain a plurality of first global recovery features of the plurality of first modal data pieces and a plurality of second global features of the plurality of second modal data pieces; perform feature prediction on the second masked data set and the first modal data set based on the feature extraction model, to obtain a plurality of first global features of the plurality of first modal data pieces and a plurality of second global recovery features of the plurality of second modal data pieces; and generate a trained feature extraction model for retrieving corresponding first modal data and second modal data by optimizing the feature extraction model based on the plurality of first global recovery features, the plurality of first global features, the plurality of first global recovery features, and the plurality of second global features.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. One of ordinary skill would understand that aspects of some embodiments may be combined together or implemented alone.

FIG. 1 is a diagram of model training framework according to some embodiments.

FIG. 2 is a flowchart of a model training method according to some embodiments.

FIG. 3 is a schematic diagram of modal data processing according to some embodiments.

FIG. 4 is a flowchart of another model training method according to some embodiments.

FIG. 5 is a display image of a model effect according to some embodiments.

FIG. 6 is a schematic structural diagram of a model training apparatus according to some embodiments.

FIG. 7 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. It may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The disclosure relates to artificial intelligence, a computer vision technology, a natural language processing technology, and deep learning. The following briefly describes the related technologies.

Artificial intelligence (AI) is a theory, a method, a technology, and an application system that use a digital computer or a machine controlled by the digital computer to simulate, extend, and expand human intelligence, perceive an environment, obtain knowledge, and use the knowledge to obtain an optimal result. In other words, artificial intelligence is a comprehensive technology in computer science that seeks to understand the nature of intelligence, and produce a new intelligent machine that can respond in a manner similar to human intelligence. The artificial intelligence is to study design principles and implementation methods of various intelligent machines, to enable the machines to have functions of perception, reasoning, and decision-making. The application of some embodiments to AI technology mainly involves extracting features of multi-modal data by using a feature extraction model, and analyzing semantic correlations between different modal data by using the extracted features.

AI technology is a comprehensive discipline, and relates to a wide range of fields including both a hardware-level technology and a software-level technology. Artificial intelligence technologies include technologies such as a sensor, a dedicated artificial intelligence chip, cloud computing, distributed storage, a technology of processing a large application, an operating/interaction system, and electromechanical integration. Artificial intelligence software technologies mainly include several major directions such as a computer vision technology, a speech processing technology, a natural language processing technology, and machine learning/deep learning.

The computer vision (CV) technology is a science that studies how to make a machine “see”. The computer vision technology refers to using a camera and a computer to replace human eyes to perform machine vision such as recognition, following, and measurement on a target, and further perform graphics processing, so that the computer processes an image that is more for human eyes, to observe or transmit the image to an instrument for detection. As a scientific discipline, theories and technologies related to a computer vision research attempt to establish an artificial intelligence system that can obtain information from an image or multi-dimensional data. The computer vision technologies include technologies such as image processing, image recognition, image semantic understanding, image retrieval, optical character recognition (OCR), video processing, video semantic understanding, video content/behavioral recognition, three-dimensional object reconstruction, a 3D technology, virtual reality, augmented reality, simultaneous positioning, and map construction, and further include common biometric recognition technologies such as face recognition and fingerprint recognition. The application of some embodiments to CV technology mainly involves extracting features in image (video) modal data by using a feature extraction model.

Nature Language processing (NLP) is an important direction in the computer science field and the artificial intelligence field. It studies various theories and methods that can implement effective communication between people and computers by using natural languages. Natural language processing is a comprehensive science of linguistics, computer science, and mathematics. Therefore, research in this field involves natural languages, that is, languages that people use on a daily basis, and therefore, is closely related to the study of linguistics. Natural language processing technologies include technologies such as text processing, semantic understanding, machine translation, robot query and answer, and knowledge graphs. The application of some embodiments to NLP technology mainly involves extracting features in text modal data by using a feature extraction model.

Machine learning (ML) is a multi-field cross-discipline involving a plurality of disciplines such as probability theory, statistics, approximation theory, convex analysis, and algorithmic complexity theory. It involves the study of how computers simulate or implement human learning behaviors to obtain new knowledge or skills and reorganize existing knowledge structures, to continuously improve their performance. Machine learning is the core of artificial intelligence and the fundamental way to make computers intelligent, with applications covering various fields of artificial intelligence. Machine learning and deep learning include technologies such as an artificial neural network, a confidence network, reinforcement learning, transfer learning, inductive learning, and tutorial learning. The application of some embodiments to ML technology mainly involves optimizing a feature extraction model based on a global recovery feature and a global feature corresponding to a first modal data set and a second modal data set, to promote the feature extraction model to learn an alignment between a global feature and a local feature, thereby improving accuracy of a prediction result of the feature extraction model.

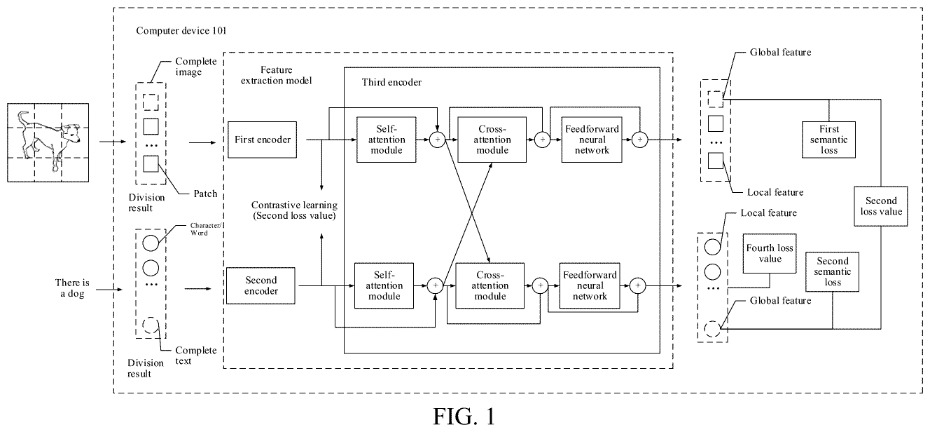

Some embodiments provide a model training solution, to improve accuracy of a prediction result of a feature extraction model. FIG. 1 is a diagram of a model training framework according to some embodiments. As shown in FIG. 1, the model training framework may be mounted in a computer device 101. The computer device 101 may be a terminal device or a server. The terminal device may include, but is not limited to, a smartphone (such as an Android mobile phone or an iOS mobile phone), a tablet computer, a portable personal computer, a mobile Internet device (MID), an in-vehicle terminal, a smart appliance, an unmanned aerial vehicle, a wearable device, and the like. The disclosure is not limited thereto. The server may be an independent physical server, or a server cluster including a plurality of physical servers or a distributed system, or may be a cloud server that provides cloud computing services such as a cloud service, a cloud database, cloud computing, a cloud function, cloud storage, a network service, cloud communication, a middleware service, a domain name service, a security service, a content delivery network (CDN), and big data and an artificial intelligence platform. The disclosure is not limited thereto.

A quantity of computer devices in FIG. 1 is merely used as an example, and is not limited. For example, the model training framework in FIG. 1 may be separately mounted in a plurality of computer devices, and the computer devices may be connected in a wired or wireless manner. The disclosure is not limited thereto.

In some embodiments, a principle of the model training solution is as follows.

(1) The computer device 101 obtains a first modal data set and a second modal data set. The first modal data set includes M pieces of first modal data, each piece of first modal data includes at least two pieces of first sub-modal data, and each piece of first sub-modal data may be referred to as a token. For example, assuming that the first modal data is a text, the first sub-modal data may refer to a character (or word) obtained after word segmentation processing is performed on the text, and each character (or word) obtained after the word segmentation processing may be referred to as a token. The second modal data set includes M pieces of second modal data, each piece of second modal data includes at least two pieces of second sub-modal data, and each piece of second sub-modal data may be referred to as a token. For example, assuming that the second modal data is an image, the second sub-modal data may be a patch obtained after patch division is performed on the image, each second patch may be referred to as a token, and M is an integer greater than 1.

A type of the first modal data is different from a type of the second modal data. For example, the first modal data is a text, and the second modal data is an image. For another example, the first modal data is a video, and the second modal data is a text. The M pieces of first modal data and the M pieces of second modal data are in a one-to-one correspondence. The one-to-one correspondence refers to that one piece of first modal data and one piece of second modal data correspond to each other, one piece of second modal data and one piece of first modal data correspond to each other, and different first modal data respectively correspond to different second modal data. Corresponding in a semantic space may be understood as that a feature of the first modal data matches a feature of the second modal data in the semantic space (a matching degree is greater than a preset threshold). The semantic space refers to a mathematical space for describing a semantic correlation. In the field of natural language processing, the semantic space may be configured to represent a semantic correlation between words, phrases, or sentences. In the field of computer vision, the semantic space may be configured to represent a semantic correlation between images. In some embodiments, the semantic space may be configured to represent a semantic correlation between the first modal data and the second modal data. The feature of the first modal data and the feature of the second modal data are mapped to the semantic space, and the matching degree (similarity) between the feature of the first modal data and the feature of the second modal data may be calculated. In the real world (the actual world that can be experienced and perceived), corresponding may be understood as that the first modal data and the second modal data may describe each other. For example, the first modal data is an image I, and the second modal data is a text A, the text A may be summarized by using content in the image I, and the content in the image I may also be described by using the text A.

(2) The computer device 101 obtains a first masked data set and a second masked data set. The first masked data set is obtained by masking at least one piece of first sub-modal data included in each piece of first modal data in the first modal data set, and the second masked data set is obtained by masking at least one piece of second sub-modal data included in each piece of second modal data in the second modal data set. Masking is a processing method for masking or covering data. In this method, an operation such as modifying, hiding, or blurring data is performed on the data, to prevent the data from being obtained or identified. For different types of modal data, masking manners may be different. For example, for the text, masking may refer to replacing at least one token (a character or a word) in the text with a preset identifier, or with another character (or word), and the another character (or word) mentioned herein refers to a character (or word) different from a masked character (or word); for the image, masking may refer to replacing at least one token (a patch) in the image with a preset identifier, or replacing at least one token (a patch) in the image with any other image, and the any other image mentioned herein refers to an image different from a masked patch.

(3) The computer device 101 performs feature prediction on the first masked data set and the second modal data set by using a feature extraction model, to obtain a global recovery feature of each piece of first modal data and a global feature of each piece of second modal data.

In some embodiments, the feature extraction model includes a first encoder, a second encoder, and a third encoder. The first encoder and the second encoder are single-modal encoders, and the third encoder is a cross-modal encoder. The single-modal encoder is configured to extract a feature of single-modal data, and the cross-modal encoder is configured to enhance interaction between features of multi-modal data. The computer device 101 encodes each piece of first masked data in the first masked data set by using the first encoder, to obtain first feature information of each piece of first masked data. The computer device 101 encodes each piece of second modal data in the second modal data set by using the second encoder, to obtain second feature information of each piece of second modal data. After obtaining the first feature information of each piece of first masked data and the second feature information of each piece of second modal data, the computer device 101 performs feature interaction on M pieces of first feature information and M pieces of second feature information by using the third encoder, to obtain the global recovery feature of each piece of first modal data and the global feature of each piece of second modal data.

(4) The computer device 101 performs feature prediction on the second masked data set and the first modal data set by using the feature extraction model, to obtain a global feature of each piece of first modal data and a global recovery feature of each piece of second modal data.

Similar to operation (3), the feature extraction model includes the first encoder, the second encoder, and the third encoder. The computer device 101 encodes each piece of first modal data in the first modal data set by using the first encoder, to obtain third feature information of each piece of first modal data. The computer device 101 encodes each piece of second masked data in the second masked data set by using the second encoder, to obtain fourth feature information of each piece of second masked data. After obtaining the third feature information of each piece of first modal data and the fourth feature information of each piece of second masked data, the computer device 101 performs feature interaction on M pieces of third feature information and M pieces of fourth feature information by using the third encoder, to obtain the global feature of each piece of first modal data and the global recovery feature of each piece of second masked data.

(5) The computer device 101 optimizes the feature extraction model based on the global recovery feature of each piece of first modal data, the global feature of each piece of first modal data, the global recovery feature of each piece of second modal data, and the global feature of each piece of second modal data, to obtain the optimized feature extraction model. The optimized feature extraction model may be configured to retrieve multi-modal data having a correspondence. For example, the second modal data corresponding to target first modal data in the second modal data set is retrieved, and the target first modal data may be data in any one piece of first modal data. For another example, the first modal data corresponding to target second modal data in the first modal data set is retrieved, and the target second modal data may be data in any one piece of second modal data.

In some embodiments, the computer device 101 calculates a first semantic loss value based on similarities between the global recovery feature of each piece of first modal data and global features of the M pieces of first modal data. The computer device 101 calculates a second semantic loss value based on similarities between the global recovery feature of each piece of second modal data and global features of the M pieces of second modal data. After obtaining the first semantic loss value and the second semantic loss value, the computer device 101 performs summation on the first semantic loss value and the second semantic loss value, to obtain a first loss value, and optimizes the feature extraction model based on the first loss value (for example, adjusting a quantity of network layers in the feature extraction model, a quantity of convolution kernels in the network layers, and scales of the convolution kernels in the network layers), to obtain the optimized feature extraction model.

In some embodiments, the first modal data set and the second modal data set are obtained, the first modal data set includes the M pieces of first modal data, each piece of first modal data includes the at least two pieces of first sub-modal data, the second modal data set includes the M pieces of second modal data, each piece of second modal data includes the at least two pieces of second sub-modal data, and the M pieces of first modal data are in a one-to-one correspondence with the M pieces of second modal data. Model training is performed by selecting different types of modal data that correspond to each other, so that the feature extraction model can capture a semantic correlation between multi-modal data, and a heterogeneous gap between different modal data can be reduced through training and learning, thereby improving accuracy of a prediction result of the model. The first masked data set and the second masked data set are obtained, the first masked data set is obtained by masking the at least one piece of first sub-modal data included in each piece of first modal data in the first modal data set, and the second masked data set is obtained by masking the at least one piece of second sub-modal data included in each piece of second modal data in the second modal data set. The correspondence between the first modal data and the second modal data can be expanded into two groups of corresponding data: one group is a correspondence between the first masked data and the second modal data, and the other group is a correspondence between the second masked data and the first modal data. The masked modal data may learn lost semantic information from other unmasked modal data, the first masked data may learn, from the second modal data, semantic information lost due to masking, and the second masked data may learn, from the first modal data, semantic information lost due to masking. Feature prediction is performed on the first masked data set and the second modal data set by using the feature extraction model, to obtain the global recovery feature of each piece of first modal data and the global feature of each piece of second modal data. Feature prediction is performed on the second masked data set and the first modal data set by using the feature extraction model, to obtain the global feature of each piece of first modal data and the global recovery feature of each piece of second modal data. A semantic correlation relationship between the two groups of corresponding data in terms of global representations can be mined through feature prediction of the feature extraction model, and the unmasked modal data is captured to recover the semantic information lost due to the masked modal data, thereby enhancing a global representation of each piece of modal data. The feature extraction model is optimized based on the global recovery feature of each piece of first modal data, the global feature of each piece of first modal data, the global recovery feature of each piece of second modal data, and the global feature of each piece of second modal data. The optimization can promote the feature extraction model to extract richer cross-modal global representations, thereby improving the accuracy of the prediction result of the feature extraction model.

Based on the foregoing model training solution, some embodiments provide a more detailed model training method. The following describes the model training method according to some embodiments in detail with reference to the accompanying drawings.

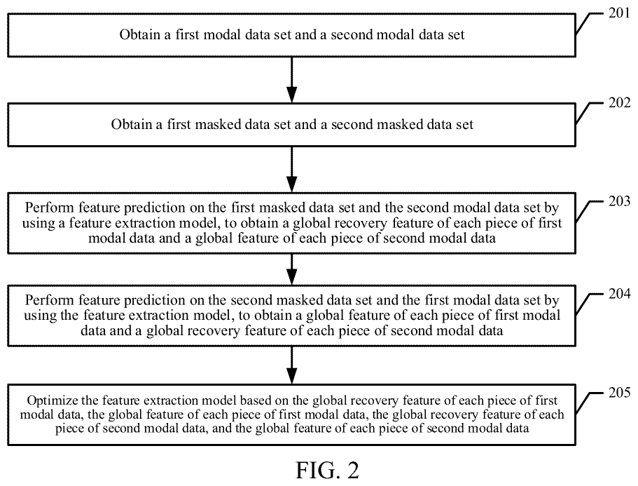

FIG. 2 is a flowchart of a model training method according to some embodiments. The model training method may be performed by a computer device, and the computer device may be a terminal device or a server. As shown in FIG. 2, the model training method may include the following operations 201 to 205.

201: Obtain a first modal data set and a second modal data set.

202: Obtain a first masked data set and a second masked data set.

In some embodiments, the computer device divides each piece of first modal data in the first modal data set, each piece of first modal data is divided into a first data sequence, and each first data sequence includes at least two pieces of first sub-modal data. The computer device divides each piece of second modal data in the second modal data set, each piece of second modal data is divided into a second data sequence, and each second data sequence includes at least two pieces of second sub-modal data. The division refers to a process of dividing a whole into several parts. For different types of modal data, the division may have different meanings. For example, when the first modal data is a text, dividing the first modal data may refer to performing word segmentation processing on the text. For another example, when the second modal data is an image, dividing the second modal data may refer to performing patch division processing on the image. The first data sequence refers to a sequence formed by sequentially arranging each piece of first sub-modal data obtained by dividing the first modal data. For example, when the first modal data is a text, the first data sequence is a sequence formed by sequentially arranging tokens (that is, characters or words) formed after word segmentation processing is performed on the text. The second data sequence refers to a sequence formed by sequentially arranging each piece of second sub-modal data obtained by dividing the second modal data. For example, when the second modal data is an image, the second data sequence is a sequence formed by sequentially arranging tokens (that is, patches) obtained after patch division processing is performed on the image.

The computer device masks at least one piece of first sub-modal data in each first data sequence, to obtain the first masked data set. A quantity of pieces of masked first sub-modal data in different first modal data may be the same or different, and the quantity of pieces of masked first sub-modal data in each piece of first modal data may be adjusted based on an actual situation (for example, a masking proportion of each piece of first modal data is adjusted). The disclosure is not limited thereto. The masking proportion refers to a percentage of a quantity of pieces of sub-modal data that may be masked in the modal data to a total quantity of pieces of sub-modal data included in the modal data. For example, if a piece of first modal data includes 10 pieces of first sub-modal data in total, and a quantity of pieces of first sub-modal data that may be masked is 5, the masking proportion of the first modal data is 5/10*100%=50%. In some embodiments, the masking refers to replacing at least one piece of sub-modal data included in the modal data with a preset identifier, or with another disturbance data. For example, if a type of the modal data is a text, a piece of sub-modal data may be referred to as a token, and a token refers to a character or a word obtained after word segmentation processing is performed on the text. The masking may be understood as replacing at least one token in the text (modal data) with a preset identifier, or with another character or phrase. For another example, if a type of the modal data is an image, a piece of sub-modal data may be referred to as a token, and a token refers to a patch obtained after patch division is performed on the image. The masking may be understood as replacing at least one token in the image (modal data) with a preset identifier, or with any other image.

The computer device masks the at least one piece of second sub-modal data included in each second data sequence, to obtain the second masked data set. In some embodiments, the computer device may obtain a masking proportion of each piece of second modal data, and mask at least one piece of second sub-modal data in the second modal data based on the masking proportion of each piece of second modal data, to obtain the second masked data set. For example, a masking proportion of a piece of second modal data is 40%, and the second modal data includes 10 pieces of second sub-modal data in total. The computer device determines, based on the masking proportion of the second modal data, that a quantity of pieces of second sub-modal data that may be masked is 4, so that the computer device may randomly select 4 pieces of second sub-modal data for masking (for example, replace the 4 pieces of selected second sub-modal data with the preset identifier).

203: Perform feature prediction on the first masked data set and the second modal data set by using a feature extraction model, to obtain a global recovery feature of each piece of first modal data and a global feature of each piece of second modal data.

The feature extraction model includes a first encoder, a second encoder, and a third encoder. The first encoder and the second encoder are single-modal encoders, and the third encoder is a cross-modal encoder. The single-modal encoder is configured to extract a feature of single-modal data, and the cross-modal encoder is configured to enhance interaction between features of multi-modal data.

In some embodiments, the computer device encodes each piece of first masked data in the first masked data set by using the first encoder, to obtain first feature information of each piece of first masked data. The computer device encodes each piece of second modal data in the second modal data set by using the second encoder, to obtain second feature information of each piece of second modal data.

It is assumed that any one piece of first masked data in the first masked data set is represented as an i^{th} piece of first masked data, the i^{th} piece of first masked data is obtained by masking the i^{th} piece of first modal data in the first modal data set, first feature information of the i^{th} piece of first masked data is represented as an i^{th} piece of first feature information, and i is a positive integer less than or equal to M. Because the i^{th} piece of first masked data is obtained after masking the i^{th} piece of first modal data, the i^{th} piece of first feature information may include the following (1) to (3): (1) A local feature of the i^{th} piece of first modal data, where the local feature of the i^{th} piece of first modal data refers to a feature of each piece of unmasked first sub-modal data in the i^{th} piece of first modal data; (2) A local recovery feature of the i^{th} piece of first modal data, where the local recovery feature of the i^{th} piece of first modal data is a recovery feature of each piece of masked first sub-modal data in the i^{th} piece of first modal data, for example, the local recovery feature of the i^{th} piece of first modal data may be obtained by recovering the local feature of the i^{th} piece of first modal data, and i is a positive integer less than or equal to M; and (3) A global recovery feature of the i^{th} piece of first modal data, where the global recovery feature of the i^{th} piece of first modal data is an overall feature of the i^{th} piece of first masked data after recovery, for example, the global recovery feature of the i^{th} first modal data may be directly obtained by combining the local feature and the local recovery feature of the i^{th} first modal data, or may be obtained after further processing (such as denoising and feature extraction) is performed on a combination of the local feature and the local recovery feature of the i^{th} first modal data.

It is assumed that any one piece of second modal data in the second modal data set is represented as an i^{th} piece of second modal data, and second feature information of the i^{th} piece of second modal data is represented as an i^{th} piece of second feature information. The i^{th} piece of second feature information includes the following (4) and (5): (4) A local feature of the i^{th} piece of second modal data, where the local feature of the i^{th} piece of second modal data refers to a feature of each piece of second sub-modal data in the i^{th} piece of second modal data; and (5) A global feature of the i^{th} piece of second modal data, where the global feature of the i^{th} piece of second modal data is an overall feature of the i^{th} piece of second modal data, for example, the global feature of the i^{th} second modal data may be directly obtained by combining local features of the i^{th} second modal data, or may be obtained after further processing (such as denoising and feature extraction) is performed on a combination of the local features of the i^{th} second modal data.

After obtaining the first feature information of each piece of first masked data and the second feature information of each piece of second modal data, the computer device performs feature interaction on M pieces of first feature information and M pieces of second feature information by using the third encoder, to obtain the global recovery feature of each piece of first modal data and the global feature of each piece of second modal data.

The third encoder includes a self-attention mechanism module and a cross-attention mechanism module. A process of the computer device performing feature interaction on the M pieces of first feature information and the M pieces of second feature information by using the third encoder includes: (1) An association relationship between features in each piece of first feature information is mined by using the self-attention mechanism module. The i^{th} piece of first feature information includes the local feature of the i^{th} piece of first modal data and the local recovery feature of the i^{th} piece of first modal data. Herein, an association relationship between features in the i^{th} piece of first feature information includes an association relationship between local features of the i^{th} piece of first modal data, an association relationship between local recovery features of the i^{th} piece of first modal data, and an association relationship between a local feature and a local recovery feature of the i^{th} piece of first modal data; (2) An association relationship between features in each piece of second feature information is mined by using the self-attention mechanism module. The i^{th} piece of second feature information includes a local feature of the i^{th} piece of second modal data. Herein, an association relationship between features in the i^{th} piece of second feature information includes an association relationship between local features of the i^{th} piece of second modal data; and (3) Feature interaction is performed on M pieces of first feature information after mining and M pieces of second feature information after mining by using the cross-attention mechanism module. For example, assuming that a type of the first modal data is an image, a type of the first masked data is also an image, and when the second modal data is a text, the computer device may use the first feature information after mining of the first masked data as a query, and use the second feature information after mining of the second modal data as an answer (key and value) to perform feature interaction. In some embodiments, because the first feature information may further include the global recovery feature of the first modal data, the computer device may further use the global recovery feature of the first modal data as a query, and use the mined second feature information of the second modal data as an answer (key and value) to perform feature interaction.

204: Perform feature prediction on the second masked data set and the first modal data set by using the feature extraction model, to obtain a global feature of each piece of first modal data and a global recovery feature of each piece of second modal data.

In some embodiments, the computer device encodes each piece of first modal data in the first modal data set by using the first encoder, to obtain third feature information of each piece of first modal data. The computer device encodes each piece of second masked data in the second masked data set by using the second encoder, to obtain fourth feature information of each piece of second masked data.

It is assumed that any one piece of first modal data in the first modal data set is represented as the i^{th} piece of first modal data, third feature information of the i^{th} piece of first modal data is represented as an i^{th} piece of third feature information. The i^{th} piece of third feature information includes the following (1) and (2): (1) The local feature of the i^{th} piece of first modal data, where the local feature of the i^{th} piece of first modal data refers to a feature of each piece of first sub-modal data in the i^{th} piece of first modal data; and (2) A global feature of the i^{th} piece of first modal data, where the global feature of the i^{th} piece of first modal data is an overall feature of the i^{th} piece of first modal data, for example, the global feature of the i^{th} piece of first modal data may be directly obtained by combining the local features of the i^{th} piece of first modal data, or may be obtained after further processing (such as denoising and feature extraction) is performed on a combination of the local features of the i^{th} piece of first modal data.

It is assumed that any one piece of second masked data in the second masked data set is represented as an i^{th} piece of second masked data, the i^{th} piece of second masked data is obtained by masking the i^{th} piece of second modal data in the second modal data set, fourth feature information of the i^{th} piece of second masked data is represented as an i^{th} piece of fourth feature information, and i is a positive integer less than or equal to M. Because the i^{th} piece of second masked data is obtained after masking the i^{th} piece of second modal data, the i^{th} piece of fourth feature information may include the following (4) to (6): (4) The local feature of the i^{th} piece of second modal data, where the local feature of the i^{th} piece of second modal data refers to a feature of each piece of unmasked second sub-modal data in the i^{th} piece of second modal data; (5) A local recovery feature of the i^{th} piece of second modal data, where the local recovery feature of the i^{th} piece of second modal data refers to a recovery feature of each piece of masked second sub-modal data in the i^{th} piece of second modal data, for example, the local recovery feature of the i^{th} piece of second modal data may be obtained by recovering the local feature of the i^{th} piece of second modal data, and i is a positive integer less than or equal to M; and (6) A global recovery feature of the i^{th} piece of second modal data, where the global recovery feature of the i^{th} piece of second modal data refers to an overall feature of the i^{th} piece of second masked data after recovery, for example, the global recovery feature of the i^{th} second modal data may be directly obtained by combining the local feature and the local recovery feature of the i^{th} second modal data, or may be obtained after further processing (such as denoising and feature extraction) is performed on a combination of the local feature and the local recovery feature of the i^{th} second modal data.

After obtaining the third feature information of each piece of first modal data and the fourth feature information of each piece of second masked data, the computer device performs feature interaction on M pieces of third feature information and M pieces of fourth feature information by using the third encoder, to obtain the global feature of each piece of first modal data and the global recovery feature of each piece of second modal data.

A process of the computer device performing feature interaction on the M pieces of third feature information and the M pieces of fourth feature information by using the third encoder includes: (1) An association relationship between features in each piece of third feature information is mined by using the self-attention mechanism module. The i^{th} piece of third feature information includes the local feature of the i^{th} piece of first modal data. Herein, an association relationship between features in the i^{th} piece of third feature information includes an association relationship between local features of the i^{th} piece of first modal data; (2) An association relationship between features in each piece of fourth feature information is mined by using the self-attention mechanism module. The i^{th} piece of fourth feature information includes the local feature of the i^{th} piece of second modal data and the local recovery feature of the i^{th} piece of second modal data. Herein, an association relationship between features in the i^{th} piece of fourth feature information includes the association relationship between local features of the i^{th} piece of second modal data, an association relationship between local recovery features of the i^{th} piece of second modal data, and an association relationship between local features of the i^{th} piece of second modal data and the local recovery features; and (3) Feature interaction is performed on M pieces of third feature information after mining and M pieces of mined fourth feature information after mining by using the cross-attention mechanism module.

205: Optimize the feature extraction model based on the global recovery feature of each piece of first modal data, the global feature of each piece of first modal data, the global recovery feature of each piece of second modal data, and the global feature of each piece of second modal data. The optimized feature extraction model may be configured to retrieve multi-modal data having a correspondence. For example, the second modal data corresponding to the target first modal data in the second modal data set is retrieved. Herein, the target first modal data may refer to any one piece of first modal data.

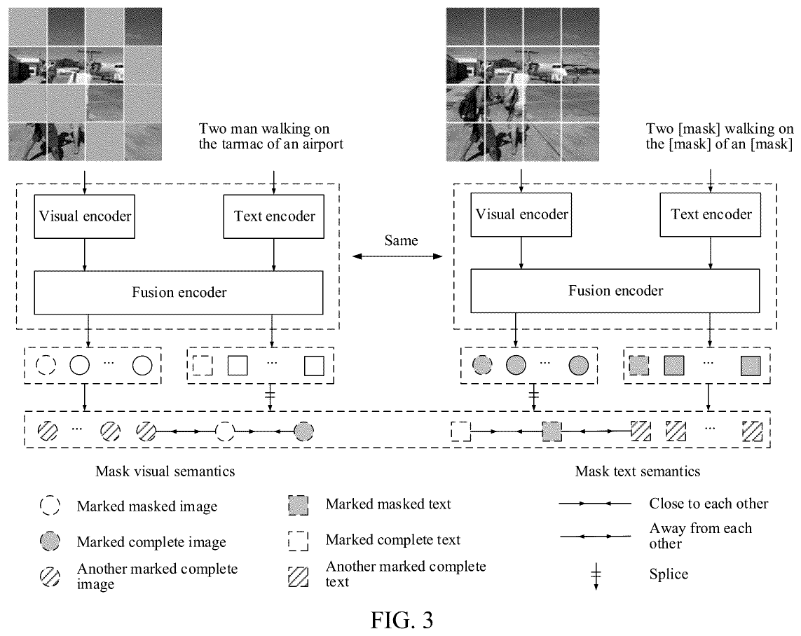

FIG. 3 is a schematic diagram of modal data processing according to some embodiments. As shown in FIG. 3, in a process of optimizing a feature extraction model, the feature extraction model may recover an overall feature of masked data (a global recovery feature of modal data to which the masked data belongs) through cross-modal interaction. It is assumed that in first modal data and second modal data that correspond to each other, the first modal data is an image I, and the second modal data is a text T. A token in the first modal data is randomly masked based on a masking proportion of the first modal data, to obtain first masked data Iₘₐₛₖ. A token in the second modal data is randomly masked based on a masking proportion of the second modal data, to obtain second masked data Tₘₐₛₖ. Therefore, masked modal data may learn lost semantic information from other unmasked modal data, the first masked data may learn, from the second modal data, semantic information lost due to masking, and the second masked data may learn, from the first modal data, semantic information lost due to masking. For example, the masking proportion of the first modal data (a type of the first modal data is an image) may be 80%, that is, 80% of patches in the image are masked, and the masking proportion of the second modal data (a type of the second modal data is a text) may be 40%, that is, 40% of tokens (characters or words) in the text are masked. Then, two groups of corresponding data (one group includes the first masked data and the second modal data, and is represented as {Iₘₐₛₖ, T}; and the other group includes the first modal data and the second masked data, and is represented as {I, Tₘₐₛₖ}) are separately inputted into the feature extraction model for processing, a global recovery feature of the modal data is obtained by using cross-modal information in each group, and the global recovery feature is made to close to a global feature through contrastive learning.

In some embodiments, the computer device calculates a first semantic loss value based on similarities between a global recovery feature of each piece of first modal data and global features of M pieces of first modal data. This may be represented as:

$${NCE}_{V} = - \frac{1}{M} {\sum }_{i = 1}^{M} log \frac{exp ( s ( {I}_{Re}^{i} , {I}_{Co}^{i} ) / τ )}{{\sum }_{n = 1}^{M} exp ( s ( {I}_{Re}^{i} , {I}_{Co}^{n} ) / τ )}$$

where NCE_{V} is the first semantic loss value, I_{Re}ⁱ represents a global recovery feature of an i^{th} piece of first modal data, I_{Co}ⁱ represents a global feature of the i^{th} piece of first modal data, s (x, y) represents calculating a cosine similarity between x and y, exp ( ) is an exponential function, t is a temperature coefficient, and M is a quantity of pieces of first modal data in the first modal data set.

The computer device calculates a second semantic loss value based on similarities between a global recovery feature of each piece of second modal data and global features of M pieces of second modal data. This may be represented as:

$${NCE}_{L} = - \frac{1}{M} {\sum }_{i = 1}^{M} log \frac{exp ( s ( {T}_{Re}^{i} , {T}_{C o}^{i} ) / τ )}{{\sum }_{n = 1}^{M} exp ( s ( {T}_{Re}^{i} , {T}_{Co}^{n} ) / τ )}$$

where NCE_{L} is the second semantic loss value, Tᵣₑⁱ represents a global recovery feature of an i^{th} piece of second modal data, T_{Co}ⁱ represents a global feature of the i^{th} piece of second modal data, s (x, y) represents calculating a cosine similarity between x and y, exp ( ) is an exponential function, t is a temperature coefficient, and M is a quantity of pieces of second modal data in the second modal data set.

After obtaining the first semantic loss value and the second semantic loss value, the computer device performs summation on the first semantic loss value and the second semantic loss value, to obtain a first loss value. This may be represented as:

$${L}_{SCL} = {NCE}_{V} + {NCE}_{L}$$

where L_{SCL} is the first loss value, NCE_{V} is the first semantic loss value, and NCE_{L} is the second semantic loss value.

After obtaining the first loss value, the computer device may optimize the feature extraction model based on the first loss value (for example, adjusting a quantity of network layers in the feature extraction model, a quantity of convolution kernels in the network layers, and scales of the convolution kernels in the network layers), to obtain the optimized feature extraction model.

In some embodiments, the first modal data set and the second modal data set are obtained, the first modal data set includes the M pieces of first modal data, each piece of first modal data includes at least two pieces of first sub-modal data, the second modal data set includes the M pieces of second modal data, each piece of second modal data includes at least two pieces of second sub-modal data, and the M pieces of first modal data are in a one-to-one correspondence with the M pieces of second modal data. Model training is performed by selecting different types of modal data that correspond to each other, so that the feature extraction model can capture a semantic correlation between multi-modal data, and a heterogeneous gap between different modal data can be reduced through training and learning, thereby improving accuracy of a prediction result of the model. The first masked data set and the second masked data set are obtained, the first masked data set is obtained by masking at least one piece of first sub-modal data included in each piece of first modal data in the first modal data set, and the second masked data set is obtained by masking at least one piece of second sub-modal data included in each piece of second modal data in the second modal data set. The correspondence between the first modal data and the second modal data can be expanded into two groups of corresponding data: one group is a correspondence between the first masked data and the second modal data, and the other group is a correspondence between the second masked data and the first modal data. The masked modal data may learn lost semantic information from other unmasked modal data, the first masked data may learn, from the second modal data, semantic information lost due to masking, and the second masked data may learn, from the first modal data, semantic information lost due to masking. Feature prediction is performed on the first masked data set and the second modal data set by using the feature extraction model, to obtain the global recovery feature of each piece of first modal data and a global feature of each piece of second modal data. Feature prediction is performed on the second masked data set and the first modal data set by using the feature extraction model, to obtain a global feature of each piece of first modal data and the global recovery feature of each piece of second modal data. A semantic correlation relationship between the two groups of corresponding data in terms of global representations can be mined through feature prediction of the feature extraction model, and the unmasked modal data is captured to recover the semantic information lost due to the masked modal data, thereby enhancing a global representation of each piece of modal data. The feature extraction model is optimized based on the global recovery feature of each piece of first modal data, the global feature of each piece of first modal data, the global recovery feature of each piece of second modal data, and the global feature of each piece of second modal data. The optimization can promote the feature extraction model to extract richer cross-modal global representations, thereby improving the accuracy of the prediction result of the feature extraction model.

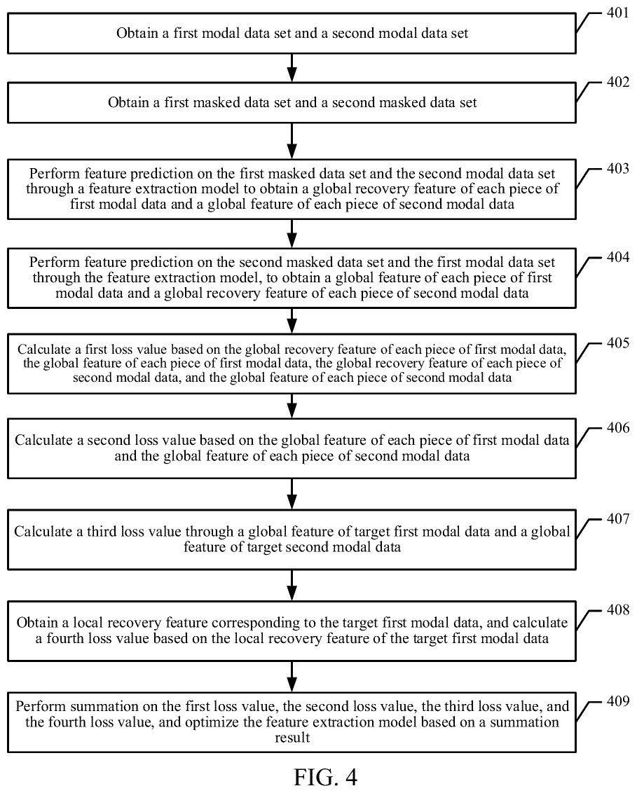

FIG. 4 is a flowchart of another model training method according to some embodiments. The model training method may be performed by a computer device, and the computer device may be a terminal device or a server. As shown in FIG. 4, the model training method may include the following operations 401 to 409.

401: Obtain a first modal data set and a second modal data set.

402: Obtain a first masked data set and a second masked data set.

For additional implementation details of operations 401 and 402, reference may be made to the descriptions of operations 201 and 202 in FIG. 2.

403: Perform feature prediction on the first masked data set and the second modal data set by using a feature extraction model, to obtain a global recovery feature of each piece of first modal data and a global feature of each piece of second modal data.

It is assumed that in the first modal data and the second modal data that correspond to each other, the first modal data is an image I, and the second modal data is a text T. A token in the first modal data is randomly masked based on a masking proportion of the first modal data, to obtain first masked data Iₘₐₛₖ. A token in the second modal data is randomly masked based on a masking proportion of the second modal data, to obtain second masked data Tₘₐₛₖ. Therefore, masked modal data may learn lost semantic information from other unmasked modal data, the first masked data may learn, from the second modal data, semantic information lost due to masking, and the second masked data may learn, from the first modal data, semantic information lost due to masking. Then, two groups of corresponding data (one group includes the first masked data and the second modal data, and is represented as {Iₘₐₛₖ, T}; and the other group includes the first modal data and the second masked data, and is represented as {I, Tₘₐₛₖ}) are separately inputted into the feature extraction model for processing.

In some embodiments, the computer device may perform, by using the feature extraction model, feature prediction on the first masked data and the second modal data that correspond to each other in the first masked data set and the second modal data set, to obtain the global recovery feature (a local feature and a local recovery feature) of the first modal data to which the first masked data belongs, and the global feature (a local feature) of the second modal data. This may be represented as:

$${I}_{Re} , {T}_{Co} = Model ( {I}_{mask} , T )$$

where I_{Re} is the global recovery feature of the first modal data, T_{Co} is the global feature of the second modal data, Iₘₐₛₖ is the first masked data, T is the second modal data, and Model(a, b) represents performing feature prediction on a and b in a group of corresponding input data {a, b} by using the feature extraction model.

According to the foregoing implementation, the computer device repeatedly invokes the feature extraction model to perform feature prediction on data corresponding to each other in the first masked data set and the second modal data set, to obtain the global recovery feature of each piece of first modal data and the global feature of each piece of second modal data.

404: Perform feature prediction on the second masked data set and the first modal data set by using the feature extraction model, to obtain a global feature of each piece of first modal data and a global recovery feature of each piece of second modal data.

In some embodiments, the computer device may perform, by using the feature extraction model, feature prediction on the second masked data and the first modal data that correspond to each other in the second masked data set and the first modal data set, to obtain the global recovery feature (a local feature and a local recovery feature) of the second modal data to which the second masked data belongs, and the global feature (a local feature) of the first modal data. This may be represented as:

$${I}_{Co} , {T}_{Re} = Model ( I , {T}_{mask} )$$

where I_{Co} is the global feature of the first modal data, T_{Re} is the global recovery feature of the second modal data, I is the first modal data, Tₘₐₛₖ is the second masked data, and Model(a, b) represents performing feature prediction on a and b in a group of corresponding input data {a, b} by using the feature extraction model.

According to the foregoing implementation, the computer device repeatedly invokes the feature extraction model to perform feature prediction on data corresponding to each other in the second masked data set and the first modal data set, to obtain the global feature of each piece of first modal data and the global recovery feature of each piece of second modal data.

405: Calculate a first loss value based on the global recovery feature of each piece of first modal data, the global feature of each piece of first modal data, the global recovery feature of each piece of second modal data, and the global feature of each piece of second modal data.

For implementation details relating to operation 405, reference may be made to the calculation of the first loss value in operation 205 in FIG. 2.

406: Calculate a second loss value based on the global feature of each piece of first modal data and the global feature of each piece of second modal data.

In a process of optimizing the feature extraction model, the global feature of each piece of first modal data in the first modal data set and the global feature of each piece of second modal data in the second modal data set may be mapped to an encoding space of the respective type. For example, if the first modal data is an image, the global feature of each piece of first modal data in the first modal data set may be mapped to a visual encoding space, and if the second modal data is a text, the global feature of each piece of second modal data in the second modal data set may be mapped to a language encoding space. Then, positions of the global feature of each piece of first modal data and the global feature of each piece of second modal data in a semantic space are adjusted through contrastive learning, making features of positive samples close to each other and features of negative samples are away from each other. In the first modal data set and the second modal data set, the first modal data and the second modal data that correspond to each other are used as positive samples, and other second modal data than current second modal data in the second modal data set are negative samples for current first modal data. The current first modal data refers to first modal data that is being processed, and the current second modal data refers to second modal data that corresponds to the current first modal data. After global features of M pieces of first modal data and global features of M pieces of second modal data are mapped to the unified semantic space, the third encoder (a fusion encoder) performs (token-level) interaction on first sub-modal data (for example, a patch in an image) included in each piece of first modal data and second sub-modal data (for example, a character or a word in the text) included in each piece of second modal data.

In some embodiments, the computer device may perform operation 404, to obtain the global feature of each piece of first modal data, and perform operation 403, to obtain the global feature of each piece of second modal data. In some embodiments, the computer device may perform feature extraction on the first modal data set and the second modal data set by using the feature extraction model, to obtain the global feature of each piece of first modal data and the global feature of each piece of second modal data. The computer device encodes each piece of first modal data in the first modal data set by using the first encoder, to obtain third feature information of each piece of first modal data. The computer device encodes each piece of second modal data in the second modal data set by using the second encoder, to obtain second feature information of each piece of second modal data. After obtaining the third feature information of each piece of first modal data and the second feature information of each piece of second modal data, the computer device performs feature interaction on M pieces of third feature information and M pieces of second feature information by using the third encoder, to obtain the global feature of each piece of first modal data and the global feature of each piece of second modal data.

Some embodiments involve the computer device calculating the second loss value based on the global feature of each piece of first modal data and the global feature of each piece of second modal data is as follows.

The computer device calculates a third semantic loss value based on similarities between the global feature of each piece of first modal data and global features of the M pieces of second modal data. This may be represented as:

$${NCE}_{V 2 T} = - \frac{1}{M} {\sum }_{i = 1}^{M} log \frac{exp ( s ( {V}_{i} , {T}_{i} ) / τ )}{{\sum }_{n = 1}^{M} exp ( s ( {V}_{i} , {T}_{n} ) / τ )}$$

where NCE_{V2T} is the third semantic loss value, Vᵢ represents a global feature of an i^{th} piece of first modal data, Ti represents a global feature of an i^{th} piece of second modal data, s (x, y) represents calculating a cosine similarity between x and y, exp ( ) is an exponential function, t is a temperature coefficient, and M is a quantity of pieces of first modal data in the first modal data set.

The computer device calculates a fourth semantic loss value based on similarities between the global feature of each piece of second modal data and global features of the M pieces of first modal data. This may be represented as:

$${NCE}_{T 2 V} = - \frac{1}{M} {\sum }_{i = 1}^{M} log \frac{exp ( s ( {T}_{i} , {V}_{i} ) / τ )}{{\sum }_{n = 1}^{M} exp ( s ( {T}_{i} , {V}_{n} ) / τ )}$$

where NCE_{T2V} is the fourth semantic loss value, Ti represents the global feature of the i^{th} piece of second modal data, Vᵢ represents the global feature of the i^{th} piece of first modal data, s (x, y) represents calculating a cosine similarity between x and y, exp ( ) is an exponential function, τ is a temperature coefficient, and M is a quantity of pieces of second modal data in the second modal data set.

After obtaining the third semantic loss value and the fourth semantic loss value, the computer device performs summation on the third semantic loss value and the fourth semantic loss value, to obtain the second loss value. This may be represented as:

$${L}_{CL} = {NCE}_{V 2 T} + {NCE}_{T 2 V}$$

where L_{CL} is a second loss value, NCE_{V2T} is the third semantic loss value, and NCE_{T2V} is the fourth semantic loss value.

407: Calculate a third loss value by using a global feature of target first modal data and a global feature of target second modal data.

In a process of optimizing the feature extraction model, a global feature of marked (for example, marked through [CLS]) first modal data output by the third encoder (fusion encoder) and a global feature of marked second modal data may be spliced, and binary classification is performed on a splicing result, to assist the feature extraction model in learning a correspondence between overall information of the first modal data and overall information of the second modal data. In the first modal data set and the second modal data set, the target first modal data and the target second modal data that correspond to each other are used as positive samples, and the target first modal data is randomly replaced with other first modal data in the first modal data set, to construct negative samples.

In some embodiments, the feature extraction model performs feature extraction on the marked first modal data in the first modal data set and the marked second modal data in the second modal data set, to obtain the global feature of the target first modal data and the global feature of the target second modal data. A quantity of pieces of marked first modal data in the first modal data set may be [1, M], and a quantity of pieces of marked second modal data in the second modal data set may be [1, M]. The computer device splices the global feature of the target first modal data and the global feature of the target second modal data, to obtain a spliced feature. After the spliced feature is obtained, a matching relationship between the global feature of the target first modal data and the global feature of the target second modal data is predicted by using the spliced feature, and the third loss value is calculated based on the predicted matching relationship and a correspondence between the global feature of the target first modal data and the global feature of the target second modal data. This may be represented as:

$${L}_{VTM} = CE ( ϕ ( concat [ V , T ] ) , y )$$

where L_{VTM} is the third loss value, V is the global feature of the target first modal data, T is the global feature of the target second modal data, concat(a, b) represents connecting a feature a and a feature b, ϕ is a binary classifier, y is an actual correspondence (0 indicates no correspondence, and 1 indicates correspondence) between V and T, and CE(c, d) represents calculating a cross entropy loss of c and d.

408: Obtain a local recovery feature of the target first modal data, and calculate a fourth loss value based on the local recovery feature of the target first modal data.

Assuming that the first modal data is a text, and the second modal data is a visual (an image/video), in a process of optimizing the feature extraction model, some (at least one) characters or words (the first sub-modal data) of each text may be masked, so that the feature extraction model predicts a masked character or word (that is, masked first sub-modal data in the first modal data) based on visual information (the second modal data) and text context (that is, unmasked first sub-modal data in the first modal data). Such character/word (token)-level reconstruction may assist the model in learning an association between a language word and a visual entity, to implement accurate local-to-local alignment.

The local recovery feature of the target first modal data is obtained after the feature extraction model performs feature extraction on the masked target first modal data and the second modal data corresponding to the target first modal data.

In some embodiments, the computer device may obtain the local recovery feature of the target first modal data through operation 403, and predict the masked first sub-modal data in the target first modal data based on the local recovery feature of the target first modal data, for example, predicting an identifier (ID) of the masked first sub-modal data in the target first modal data in a vocabulary. After the masked first sub-modal data in the target first modal data is predicted, the fourth loss value is calculated based on the predicted first sub-modal data and the masked first sub-modal data in the target first modal data. This may be represented as:

$${L}_{MLM} = CE ( ϕ ( {T}_{mask} ) , y )$$

where L_{MLM} is the fourth loss value, Tₘₐₛₖ is a local recovery feature of the masked first sub-modal data in the target first modal data, ϕ( ) is a word list classifier, y is the identifier (ID) of the masked first sub-modal data in the target first modal data in the vocabulary, and CE(a, b) represents calculating a cross entropy loss of a and b.

409: Perform summation on the first loss value, the second loss value, the third loss value, and the fourth loss value, and optimize the feature extraction model based on a summation result.

The performing summation on the first loss value, the second loss value, the third loss value, and the fourth loss value may be represented as:

$$L = {L}_{CL} + {L}_{VTM} + {L}_{MLM} + {L}_{SCL}$$

where L is a total loss, L_{SCL} is the first loss value, L_{CL} is the second loss value, L_{VTM} is the third loss value, and L_{MLM} is the fourth loss value.

In some embodiments, the computer device may further calculate the total loss based on the first loss value and at least one of the second loss value or the fourth loss value. For example, the total loss is calculated based on the first loss value and the second loss value. For another example, the total loss is calculated based on the first loss value, the third loss value, and the fourth loss value.

After obtaining the total loss, the computer device may optimize the feature extraction model (for example, adjusting a quantity of network layers in the feature extraction model, a quantity of convolution kernels in the network layers, and scales of the convolution kernels in the network layers), to obtain the optimized feature extraction model.

In some embodiments, the first modal data is an image or a video, and the first encoder is a visual encoder. The first modal data set (an inputted image set or video) is first processed into a patch feature through convolution, and a size is Q×3×N×P×P, where P is a size of the patch, N is a quantity of image patches, Q is a quantity of frames, and a value of Q is 1 for image modal data, and then learnable position code and time sequence code may be further added as inputs of the feature extraction model. Then, feature extraction is performed on the patch feature by using a visual attention module stacked in the first encoder. For the visual encoder (first encoder), parameter initialization may be performed on the first encoder by using a parameter in an existing image encoder (for example, CLIP-ViT). The second modal data is a text, and the second encoder is a text encoder. For the second modal data set, word segmentation is first performed by using a word segmentation device, to obtain a character/word (token) sequence, and then the sequence is mapped to a latent state space dimension. Then, text context learning is performed on a mapping result passes by using a self-attention module stacked in the second encoder. Parameter initialization may be performed on the second encoder by using a parameter in an existing text encoder (for example, ROBERTa). The fusion encoder (third encoder) has a two-stream fusion structure, and has k (k is a positive integer, for example, k=6) layers in total, and modules of each layer include intra-modal self-attention and inter-modal cross-attention. Using a picture feature as an example, intra-modal information is mined through visual self-attention at each layer, and then the picture feature is used as a query and the text feature is used as a key and a value to perform cross-attention. A latent state space dimension of all encoders may be 768, and during pre-training, an image size may be 288×288 and a text length may be 50.

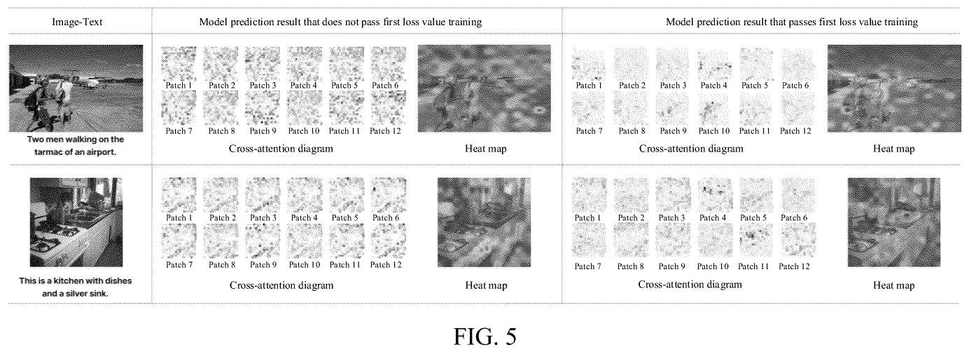

FIG. 5 is a display image of a model effect according to some embodiments. As shown in FIG. 5, after a feature extraction model is trained in the model training method provided in some embodiments, representations (a local feature and a global feature) of a text can be more accurately focused on a corresponding target in an image. A feature of masked data is recovered through a local feature of visible data (unmasked data), to obtain a global recovery feature of modal data, so that the feature extraction model learns a global feature having a strong representation capability. In the same amount of pre-training data, a prediction result of an optimized feature extraction model obtained in the model training method provided in some embodiments is more accurate, and a better effect is achieved in a plurality of downstream tasks.

The optimized feature extraction model may be applied to a plurality of scenarios such as intelligent video creation, advertisement fingerprint generation, and advertisement recommendation, to improve an overall deployment effect of a full link of an advertisement and use experience of a content consumer. Scenarios may include.

(1) Applied to intelligent video creation: video creative is automatically generated in batches based on copywriting in a cross-modal retrieval and splicing manner, which can greatly improve video creation efficiency. Specifically, text modal data of a video that may be created is given, semantic correlated video clips are retrieved from a massive video library based on the text modal data by using the optimized feature extraction model, and then the retrieved video clips are pre-ranked, ranked, and finally combined and rendered into a video based on a dimension such as a similarity or a click-through rate. Because the process is automated, video creation efficiency is greatly improved.

(2) Advertisement fingerprint generation: by using the optimized feature extraction model, similar advertisements can be better recalled and advertisement fingerprints can be better generated based on a creative multi-modal (text modal, image modal, and the like) feature, thereby improving advertisement prediction consistency and freshness of the content consumer.

(3) Advertisement recommendation: an advertising video creative may include copywriting and video materials. The optimized feature extraction model may generate semantic correlated text features and video features for one creative, and the multi-modal (text modal, image modal, and the like) feature can better represent one piece of advertising creative content. The text features and video features extracted by the optimized feature extraction model may further be applied to an advertisement recommendation model, to assist the advertisement recommendation model in better understanding advertisement content, and improve a recommendation effect (for example, make advertisement recommendation more targeted).

(4) Picture and text query and answer: the computer device may obtain a target image and a query text corresponding to the target image. Feature extraction is performed on the target image and the query text by using the optimized feature extraction model, to obtain feature information of the target image and feature information of the query text. The feature information of the target image and the feature information of the query text are classified by using a multilayer perceptron (MLP), to obtain a reply text corresponding to the query text.

In some embodiments, a first modal data set and a second modal data set are obtained, the first modal data set includes M pieces of first modal data, each piece of first modal data includes at least two pieces of first sub-modal data, the second modal data set includes M pieces of second modal data, each piece of second modal data includes at least two pieces of second sub-modal data, and the M pieces of first modal data are in a one-to-one correspondence with the M pieces of second modal data. Model training is performed by selecting different types of modal data that correspond to each other, so that the feature extraction model can capture a semantic correlation between multi-modal data, and a heterogeneous gap between different modal data can be reduced through training and learning, thereby improving accuracy of a prediction result of the model. A first masked data set and a second masked data set are obtained, the first masked data set is obtained by masking at least one piece of first sub-modal data included in each piece of first modal data in the first modal data set, and the second masked data set is obtained by masking at least one piece of second sub-modal data included in each piece of second modal data in the second modal data set. The correspondence between the first modal data and the second modal data can be expanded into two groups of corresponding data: one group is a correspondence between first masked data and the second modal data, and the other group is a correspondence between second masked data and the first modal data. Therefore, masked modal data may learn lost semantic information from other unmasked modal data, the first masked data may learn semantic information lost due to masking from the second modal data, and the second masked data may learn semantic information lost due to masking from the first modal data. Feature prediction is performed on the first masked data set and the second modal data set by using the feature extraction model, to obtain a global recovery feature of each piece of first modal data and a global feature of each piece of second modal data. Feature prediction is performed on the second masked data set and the first modal data set by using the feature extraction model, to obtain a global feature of each piece of first modal data and a global recovery feature of each piece of second modal data. A semantic correlation relationship between the two groups of corresponding data in terms of global representations can be mined through feature prediction of the feature extraction model, and the unmasked modal data is captured to recover the semantic information lost due to the masked modal data, thereby enhancing a global representation of each piece of modal data. The feature extraction model is optimized based on the global recovery feature of each piece of first modal data, the global feature of each piece of first modal data, the global recovery feature of each piece of second modal data, and the global feature of each piece of second modal data. The optimization can promote the feature extraction model to extract richer cross-modal global representations, thereby improving the accuracy of the prediction result of the feature extraction model.

The foregoing describes the method in some embodiments in detail. The following descriptions provide an apparatus in some embodiments.

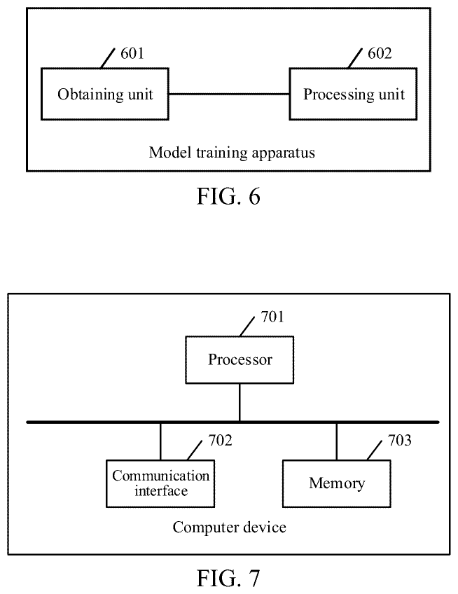

FIG. 6 is a schematic structural diagram of a model training apparatus according to some embodiments. The model training apparatus shown in FIG. 6 may be mounted in a computer device. The computer device may be a terminal device or a server. The model training apparatus shown in FIG. 6 may be configured to perform some or all of functions of the method according to some embodiments described in FIG. 2 and FIG. 4. Referring to FIG. 6, the model training apparatus includes:
an obtaining unit 601, configured to: obtain a first modal data set and a second modal data set, the first modal data set including M pieces of first modal data, each piece of first modal data including at least two pieces of first sub-modal data, the second modal data set including M pieces of second modal data, each piece of second modal data including at least two pieces of second sub-modal data, the M pieces of first modal data and the M pieces of second modal data being in a one-to-one correspondence, and M being an integer greater than 1; and
obtain a first masked data set and a second masked data set, the first masked data set being obtained by masking at least one piece of first sub-modal data included in each piece of first modal data in the first modal data set, and the second masked data set being obtained by masking at least one piece of second sub-modal data included in each piece of second modal data in the second modal data set; and
a processing unit 602, configured to: perform feature prediction on the first masked data set and the second modal data set by using a feature extraction model, to obtain a global recovery feature of each piece of first modal data and a global feature of each piece of second modal data;
perform feature prediction on the second masked data set and the first modal data set by using the feature extraction model, to obtain a global feature of each piece of first modal data and a global recovery feature of each piece of second modal data; and
optimize the feature extraction model based on the global recovery feature of each piece of first modal data, the global feature of each piece of first modal data, the global recovery feature of each piece of second modal data, and the global feature of each piece of second modal data, the optimized feature extraction model being configured to retrieve the first modal data and the second modal data that correspond to each other.

In some embodiments, the processing unit 602 may be configured to:
calculate a first semantic loss value based on similarities between the global recovery feature of each piece of first modal data and global features of the M pieces of first modal data;
calculate a second semantic loss value based on similarities between the global recovery feature of each piece of second modal data and global features of the M pieces of second modal data;
perform summation on the first semantic loss value and the second semantic loss value, to obtain a first loss value; and
optimize the feature extraction model based on the first loss value.

In some embodiments, the processing unit 602 is may be configured to:
calculate a second loss value based on the global feature of each piece of first modal data and the global feature of each piece of second modal data;
calculate a third loss value based on a global feature of target first modal data and a global feature of target second modal data, the global feature of the target first modal data and the global feature of the target second modal data being obtained by the feature extraction model performing feature extraction on marked first modal data in the first modal data set and marked second modal data in the second modal data set;
obtain a local recovery feature of the target first modal data, and calculate a fourth loss value based on the local recovery feature of the target first modal data; and
perform summation on the first loss value, the second loss value, the third loss value, and the fourth loss value, and optimize the feature extraction model based on a summation result.

In some embodiments, the processing unit 602 may be configured to:
calculate a third semantic loss value based on similarities between the global feature of each piece of first modal data and the global features of the M pieces of second modal data;
calculate a fourth semantic loss value based on similarities between the global feature of each piece of second modal data and the global features of the M pieces of first modal data; and
perform summation on the third semantic loss value and the fourth semantic loss value, to obtain the second loss value.

In some embodiments, the processing unit 602 may be configured to:
splice the global feature of the target first modal data and the global feature of the target second modal data, to obtain a spliced feature;
predict a matching relationship between the global feature of the target first modal data and the global feature of the target second modal data based on the spliced feature; and
calculate the third loss value based on the predicted matching relationship and a correspondence between the global feature of the target first modal data and the global feature of the target second modal data.

In some embodiments, the local recovery feature of the target first modal data is obtained after the feature extraction model performs feature extraction on the masked target first modal data and the second modal data corresponding to the target first modal data, and the processing unit 602 may be configured to:
predict masked first sub-modal data in the target first modal data based on the local recovery feature of the target first modal data; and
calculate the fourth loss value based on predicted first sub-modal data and the masked first sub-modal data in the target first modal data.

In some embodiments, the feature extraction model includes a first encoder, a second encoder, and a third encoder, and the processing unit 602 may be configured to:
encode each piece of first masked data in the first masked data set by using the first encoder, to obtain first feature information of each piece of first masked data.
encode each piece of second modal data in the second modal data set by using the second encoder, to obtain second feature information of each piece of second modal data; and
perform feature interaction on M pieces of first feature information and M pieces of second feature information by using the third encoder, to obtain the global recovery feature of each piece of first modal data and the global feature of each piece of second modal data.

In some embodiments, any one piece of first masked data in the first masked data set is represented as an i^{th} piece of first masked data, and the i^{th} piece of first masked data is obtained by masking an i^{th} piece of first modal data in the first modal data set; first feature information of the i^{th} piece of first masked data is represented as an i^{th} piece of first feature information, the i^{th} piece of first feature information includes a local feature and a local recovery feature of the i^{th} piece of first modal data, and i is a positive integer less than or equal to M; any one piece of second modal data in the second modal data set is represented as an i^{th} piece of second modal data, second feature information of the i^{th} piece of second modal data is represented as an i^{th} piece of second feature information, and the i^{th} piece of second feature information includes a local feature of the i^{th} piece of second modal data; and the third encoder includes a self-attention mechanism module and a cross-attention mechanism module; and the processing unit 602 may be configured to:
mine an association relationship between features in each piece of first feature information by using the self-attention mechanism module, an association relationship between features in the i^{th} piece of first feature information including an association relationship between local features of the i^{th} piece of first modal data, an association relationship between local recovery features of the i^{th} piece of first modal data, and an association relationship between local features and local recovery features of the i^{th} piece of first modal data;
mine an association relationship between features in each piece of second feature information by using the self-attention mechanism module, an association relationship between features in the i^{th} piece of second feature information including an association relationship between local features of the i^{th} piece of second modal data; and
perform feature interaction on M pieces of first feature information after mining and M pieces of second feature information after mining by using the cross-attention mechanism module.

In some embodiments, the feature extraction model includes the first encoder, the second encoder, and the third encoder, and the processing unit 602 may be configured to:
encode each piece of first modal data in the first modal data set by using the first encoder, to obtain third feature information of each piece of first modal data;
encode each piece of second masked data in the second masked data set by using the second encoder, to obtain fourth feature information of each piece of second masked data; and
perform feature interaction on M pieces of third feature information and M pieces of fourth feature information by using the third encoder, to obtain the global feature of each piece of first modal data and the global recovery feature of each piece of second modal data.

In some embodiments, the processing unit 602 may be configured to:
divide each piece of first modal data in the first modal data set, each piece of first modal data being divided into a first data sequence, and each first data sequence including the at least two pieces of first sub-modal data;
divide the second modal data in the second modal data set, each piece of second modal data being divided into a second data sequence, and each second data sequence including the at least two pieces of second sub-modal data;
mask at least one piece of first sub-modal data in each first data sequence, to obtain the first masked data set; and
mask at least one piece of second sub-modal data in each second data sequence, to obtain the second masked data set.

In some embodiments, the processing unit 602 is further configured to:
obtain a target image and a query text corresponding to the target image;
perform feature extraction on the target image and the query text by using the optimized feature extraction model, to obtain feature information of the target image and feature information of the query text; and
classify the feature information of the target image and the feature information of the query text through a multilayer perceptron, to obtain a reply text corresponding to the query text.

According to some embodiments, some operations in the model training methods shown in FIG. 2 and FIG. 4 may be performed by the units in the model training apparatus shown in FIG. 6. For example, operation 201 and 202 shown in FIG. 2 may be performed by the obtaining unit 601 shown in FIG. 6, operations 203 to 205 may be performed by the processing unit 602 shown in FIG. 6, operations 401 and 402 shown in FIG. 4 may be performed by the obtaining unit 601 shown in FIG. 6, operations 403 to operation 407, and operation 409 may be performed by the processing unit 602 shown in FIG. 6, and operation 408 may be jointly performed by the obtaining unit 601 and the processing unit 602 shown in FIG. 6. The units in the model training apparatus shown in FIG. 6 may be separately or entirely combined into one or several other units, or one (or more) of the units may further be divided into a plurality of units of smaller functions. In this way, same operations can be implemented without affecting implementation of the technical effects of some embodiments. The foregoing units are divided based on logical functions.

According to some embodiments, each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

According to some embodiments, the model training apparatus shown in FIG. 6 may be constructed and the model training method in some embodiments may be implemented by running a computer program (including program code) that can perform the operations involved in the corresponding methods shown in FIG. 2 and FIG. 4 on a computing apparatus such as a computer device that includes processing elements and storage elements such as a central processing unit (CPU), a random access storage medium (RAM), and a read-only storage medium (ROM). The computer program may be recorded in, for example, a computer-readable recording medium, and may be loaded into the foregoing computing apparatus by using the computer-readable recording medium and run in the computer device.

In some embodiments, the first modal data set and the second modal data set are obtained, the first modal data set includes the M pieces of first modal data, each piece of first modal data includes the at least two pieces of first sub-modal data, the second modal data set includes the M pieces of second modal data, each piece of second modal data includes the at least two pieces of second sub-modal data, and the M pieces of first modal data are in a one-to-one correspondence with the M pieces of second modal data. Model training is performed by selecting different types of modal data that correspond to each other, so that the feature extraction model can capture a semantic correlation between multi-modal data, and a heterogeneous gap between different modal data can be reduced through training and learning, thereby improving accuracy of a prediction result of the model. The first masked data set and the second masked data set are obtained, the first masked data set is obtained by masking the at least one piece of first sub-modal data included in each piece of first modal data in the first modal data set, and the second masked data set is obtained by masking the at least one piece of second sub-modal data included in each piece of second modal data in the second modal data set. The correspondence between the first modal data and the second modal data can be expanded into two groups of corresponding data: one group is a correspondence between the first masked data and the second modal data, and the other group is a correspondence between the second masked data and the first modal data. The masked modal data may learn lost semantic information from other unmasked modal data, the first masked data may learn, from the second modal data, semantic information lost due to masking, and the second masked data may learn, from the first modal data, semantic information lost due to masking. Feature prediction is performed on the first masked data set and the second modal data set by using the feature extraction model, to obtain the global recovery feature of each piece of first modal data and the global feature of each piece of second modal data. Feature prediction is performed on the second masked data set and the first modal data set by using the feature extraction model, to obtain the global feature of each piece of first modal data and the global recovery feature of each piece of second modal data. A semantic correlation relationship between the two groups of corresponding data in terms of global representations can be mined through feature prediction of the feature extraction model, and the unmasked modal data is captured to recover the semantic information lost due to the masked modal data, thereby enhancing a global representation of each piece of modal data. The feature extraction model is optimized based on the global recovery feature of each piece of first modal data, the global feature of each piece of first modal data, the global recovery feature of each piece of second modal data, and the global feature of each piece of second modal data. The optimization can promote the feature extraction model to extract richer cross-modal global representations, thereby improving the accuracy of the prediction result of the feature extraction model.

FIG. 7 is a schematic structural diagram of a computer device according to some embodiments. The computer device may be a terminal device or a server. As shown in FIG. 7, the computer device includes at least a processor 701, a communication interface 702, and a memory 703. The processor 701, the communication interface 702, and the memory 703 may be connected through a bus or in another manner. The processor 701 (or referred to as a central processing unit (CPU)) is a computing core and a control core of the computer device, and may parse various instructions in the computer device and process various data of the computer device. For example, the CPU may be configured to parse an on/off instruction sent by an object to the computer device, and control the computer device to perform an on/off operation. For another example, the CPU may transmit various types of interaction data between internal structures of computer devices. The communication interface 702 may include a standard wired interface and a standard wireless interface (such as a Wi-Fi or mobile communication interface), and may be configured to receive and transmit data under control of the processor 701. The communication interface 702 may further be configured to transmit and exchange data inside the computer device. The memory 703 is a storage device in the computer device, and is configured to store a program and data. The memory 703 herein may include an internal memory of the computer device, and certainly may also include an extended memory supported by the computer device. The memory 703 provides a storage space. The storage space stores an operating system of the computer device, which may include, but is not limited to, an Android system, an iOS system, a Windows Phone system, and the like. The disclosure is not limited thereto.

Some embodiments further provide a computer-readable storage medium (memory). The computer-readable storage medium is a storage device in the computer device, and is configured to store a program and data. The computer-readable storage medium herein may include a built-in storage medium in the computer device, and certainly may also include an extended storage medium supported by the computer device. The computer-readable storage medium provides a storage space, and the storage space stores a processing system of the computer device. The storage space further stores a computer program adapted to be loaded and executed by the processor 701. The computer-readable storage medium herein may be a high-speed RAM memory, or may be a non-volatile memory, for example, at least one magnetic disk memory. In some embodiments, the medium may further be at least one computer-readable storage medium located far away from the foregoing processor.

In some embodiments, the processor 701 loads and runs the computer program in the memory 703, to perform the implementations provided by the operations shown in FIG. 2 and FIG. 4. For details, reference may be to the implementations provided by the foregoing operations.

In some embodiments, a first modal data set and a second modal data set are obtained, the first modal data set includes M pieces of first modal data, each piece of first modal data includes at least two pieces of first sub-modal data, the second modal data set includes M pieces of second modal data, each piece of second modal data includes at least two pieces of second sub-modal data, and the M pieces of first modal data are in a one-to-one correspondence with the M pieces of second modal data. Model training is performed by selecting different types of modal data that correspond to each other, so that a feature extraction model can capture a semantic correlation between multi-modal data, and a heterogeneous gap between different modal data can be reduced through training and learning, thereby improving accuracy of a prediction result of the model. A first masked data set and a second masked data set are obtained, the first masked data set is obtained by masking at least one piece of first sub-modal data included in each piece of first modal data in the first modal data set, and the second masked data set is obtained by masking at least one piece of second sub-modal data included in each piece of second modal data in the second modal data set. The correspondence between the first modal data and the second modal data can be expanded into two groups of corresponding data: one group is a correspondence between first masked data and the second modal data, and the other group is a correspondence between second masked data and the first modal data. Therefore, masked modal data may learn lost semantic information from other unmasked modal data, the first masked data may learn, from the second modal data, semantic information lost due to masking, and the second masked data may learn, from the first modal data, semantic information lost due to masking. Feature prediction is performed on the first masked data set and the second modal data set by using the feature extraction model, to obtain a global recovery feature of each piece of first modal data and a global feature of each piece of second modal data. Feature prediction is performed on the second masked data set and the first modal data set by using the feature extraction model, to obtain a global feature of each piece of first modal data and a global recovery feature of each piece of second modal data. A semantic correlation relationship between the two groups of corresponding data in terms of global representations can be mined through feature prediction of the feature extraction model, and the unmasked modal data is captured to recover the semantic information lost due to the masked modal data, thereby enhancing a global representation of each piece of modal data. The feature extraction model is optimized based on the global recovery feature of each piece of first modal data, the global feature of each piece of first modal data, the global recovery feature of each piece of second modal data, and the global feature of each piece of second modal data. The optimization can promote the feature extraction model to extract richer cross-modal global representations, thereby improving the accuracy of the prediction result of the feature extraction model.

Some embodiments further provide a computer-readable storage medium. The computer-readable storage medium has a computer program stored therein, the computer program being adapted to be loaded by a processor to perform the model training method in some embodiments.

Some embodiments further provide a computer program product. The computer program product includes a computer program, the computer program being adapted to be loaded by a processor to perform the model training method in some embodiments.

Some embodiments further provide a computer program product or a computer program. The computer program product or the computer program includes computer instructions stored in a computer-readable storage medium. A processor of a computer device reads the computer instructions from the computer-readable storage medium, and the processor executes the computer instructions, to cause the computer device to execute the foregoing model training method.

The operations in the method in some embodiments may be sequentially adjusted, or combined, according to an actual requirement.

A person of ordinary skill in the art may understand that all or some of the operations of the methods in some embodiments may be implemented by a program instructing relevant hardware. The program may be stored in a computer-readable storage medium. The readable storage medium may include a flash drive, a read-only memory (ROM), a random access memory (RAM), a magnetic disk, an optical disc, or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A model training method, performed by a model training apparatus, comprising:
obtaining a first modal data set and a second modal data set, wherein the first modal data set comprises a plurality of first modal data pieces, and a first piece of the plurality of first modal data pieces comprises a plurality of first sub-modal data pieces, wherein the second modal data set comprises a plurality of second modal data pieces, and a second piece of the plurality of second modal data pieces comprises a plurality of second sub-modal data pieces, and wherein the plurality of first modal data pieces correspond to the plurality of second modal data pieces;
obtaining a first masked data set by masking at least one third piece of the plurality of first sub-modal data pieces, and obtaining a second masked data set, by masking at least one fourth piece of the plurality of second sub-modal data pieces;
performing feature prediction on the first masked data set and the second modal data set based on a feature extraction model, to obtain a plurality of first global recovery features of the plurality of first modal data pieces and a plurality of second global features of the plurality of second modal data pieces;
performing feature prediction on the second masked data set and the first modal data set based on the feature extraction model, to obtain a plurality of first global features of the plurality of first modal data pieces and a plurality of second global recovery features of the plurality of second modal data pieces; and
generating a trained feature extraction model for retrieving corresponding first modal data and second modal data by optimizing the feature extraction model based on the plurality of first global recovery features, the plurality of first global features, the plurality of second global recovery features, and the plurality of second global features.

2. The model training method according to claim 1, wherein the generating the trained feature extraction model comprises:
calculating a first semantic loss value based on similarities between the plurality of first global recovery features and the plurality of first global features;
calculating a second semantic loss value based on similarities between the plurality of second global recovery features and the plurality of second global features of the plurality of second modal data pieces;
obtaining a first loss value by performing summation on the first semantic loss value and the second semantic loss value; and
optimizing the feature extraction model based on the first loss value.

3. The model training method according to claim 2, wherein the optimizing the feature extraction model based on the first loss value comprises:
calculating a second loss value based on the plurality of first global features and the plurality of second global features;
obtaining, by performing feature extraction, via the feature extraction model, on marked first modal data in the first modal data set and marked second modal data in the second modal data set, a third global feature of target first modal data and a fourth global feature of target second modal data, and calculating a third loss value based on the third global feature and the fourth global feature;
obtaining a local recovery feature of the target first modal data, and calculating a fourth loss value based on the local recovery feature of the target first modal data; and
obtaining a summation result by performing summation on the first loss value, the second loss value, the third loss value, and the fourth loss value, and optimizing the feature extraction model based on the summation result.

4. The model training method according to claim 3, wherein the calculating the second loss value comprises:
calculating a third semantic loss value based on similarities between the plurality of first global features and the plurality of second global features;
calculating a fourth semantic loss value based on similarities between the plurality of second global features and the plurality of first global features; and
obtaining the second loss value by performing summation on the third semantic loss value and the fourth semantic loss value.

5. The model training method according to claim 3, wherein the calculating the third loss value comprises:
obtaining a spliced feature by splicing the third global feature and the fourth global feature;
obtaining a predicted matching relationship between the third global feature and the fourth global feature based on the spliced feature; and
calculating the third loss value based on the predicted matching relationship and a correspondence between the third global feature and the fourth global feature.

6. The model training method according to claim 3, wherein the local recovery feature is obtained after the feature extraction model performs feature extraction on masked target first modal data and the second modal data, and
wherein the calculating the fourth loss value based on the local recovery feature comprises:
predicting masked first sub-modal data in the target first modal data based on the local recovery feature; and
calculating the fourth loss value based on predicted first sub-modal data and the masked first sub-modal data.

7. The model training method according to claim 1, wherein the feature extraction model comprises a first encoder, a second encoder, and a third encoder, and
wherein the performing the feature prediction on the first masked data set and the second modal data set comprises:
encoding a plurality of first masked data pieces in the first masked data set by using the first encoder, to obtain first feature information of the plurality of first masked data pieces;
encoding the plurality of second modal data pieces in the second modal data set by using the second encoder, to obtain second feature information of the plurality of second modal data pieces; and
performing feature interaction on a first plurality of pieces of first feature information and a second plurality of pieces of second feature information by using the third encoder, to obtain the plurality of first global recovery features and the plurality of second global features.

8. The model training method according to claim 7, wherein a fifth piece of first masked data in the first masked data set is represented as an i^{th} piece of first masked data, and the i^{th} piece of first masked data is obtained by masking an i^{th} piece of first modal data in the first modal data set,
wherein i^{th} first feature information of the i^{th} piece of first masked data is represented as an i^{th} piece of first feature information, the i^{th} piece of first feature information comprising a first i^{th} local feature and an i^{th} local recovery feature of the i^{th} piece of first modal data, and i being a positive integer less than or equal to a number of corresponding pieces of the plurality of first modal data pieces and the plurality of second modal data pieces,
wherein a sixth piece of second modal data in the second modal data set is represented as an i^{th} piece of second modal data, i^{th} second feature information of the i^{th} piece of second modal data is represented as an i^{th} piece of second feature information, and the i^{th} piece of second feature information comprises a second i^{th} local feature of the i^{th} piece of second modal data,
wherein the third encoder comprises a self-attention mechanism and a cross-attention mechanism, and
wherein the performing the feature interaction comprises:
mining an association relationship between a first plurality of features in a piece of first feature information by using the self-attention mechanism, an association relationship between features in the i^{th} piece of first feature information comprising an association relationship between a first plurality of local features of the i^{th} piece of first modal data, an association relationship between a first plurality of local recovery features of the i^{th} piece of first modal data, and an association relationship between a local feature and a local recovery feature of the i^{th} piece of first modal data;
mining an association relationship between a second plurality of features in the second feature information by using the self-attention mechanism, an association relationship between a third plurality of features in the i^{th} piece of second feature information comprising an association relationship between a second plurality of local features of the i^{th} piece of second modal data; and
performing, based on the cross-attention mechanism, feature interaction on a plurality of pieces of first feature information after mining and a plurality of pieces of second feature infomration.

9. The model training method according to claim 7, wherein the feature extraction model comprises the first encoder, the second encoder, and the third encoder, and wherein the performing the feature prediction on the second masked data set and the first modal data set comprises:
encoding the plurality of first modal data pieces via the first encoder, to obtain third feature information of the plurality of first modal data pieces;
encoding the plurality of second masked data pieces via the second encoder, to obtain fourth feature information of the plurality of second masked data pieces; and
performing feature interaction on a third plurality of pieces of third feature information and a fourth plurality of pieces of fourth feature information via the third encoder, to obtain the plurality of first global features and the plurality of second global recovery features.

10. The model training method according to claim 1, wherein the obtaining the first masked data set and the second masked data set comprises:
dividing the plurality of first modal data pieces, a first modal data piece being divided into a first data sequence comprising the plurality of first sub-modal data pieces;
dividing the plurality of second modal data pieces, a second modal data piece being divided into a second data sequence comprising the plurality of second sub-modal data pieces;
masking, in a plurality of first data sequences, at least one first sub-modal data piece, to obtain the first masked data set; and
masking, in a plurality of second data sequences, at least one second sub-modal data piece, to obtain the second masked data set.

11. A model training apparatus, comprising:
at least one memory configured to store computer program code; and
at least one processor configured to read the program code and operate as instructed by the program code, the program code comprising:
first obtaining code configured to cause at least one of the at least one processor to: obtain a first modal data set and a second modal data set, wherein the first modal data set comprises a plurality of first modal data pieces, and a first piece of the plurality of first modal data pieces comprises a plurality of first sub-modal data pieces, wherein the second modal data set comprises a plurality of second modal data pieces, and a second piece of the plurality of second modal data pieces comprises a plurality of second sub-modal data pieces, and wherein the plurality of first modal data pieces correspond to the plurality of second modal data pieces; and
second obtaining code configured to cause at least one of the at least one processor to obtain a first masked data set by masking at least one third piece of the plurality of first sub-modal data pieces, and obtain a second masked data set by masking at least one fourth piece of the plurality of second sub-modal data pieces; and
feature prediction code configured to cause at least one of the at least one processor to:
perform feature prediction on the first masked data set and the second modal data set based on a feature extraction model, to obtain a plurality of first global recovery features of the plurality of first modal data pieces and a plurality of second global features of the plurality of second modal data pieces;
perform feature prediction on the second masked data set and the first modal data set based on the feature extraction model, to obtain a plurality of first global features of the plurality of first modal data pieces and a plurality of second global recovery features of the plurality of second modal data pieces; and
optimization code configured to cause at least one of the at least one processor to generate a trained feature extraction model for retrieving corresponding first modal data and second modal data by optimizing the feature extraction model based on the plurality of first global recovery features, the plurality of first global features, the plurality of first global recovery features, and the plurality of second global features.

12. The model training apparatus according to claim 11, wherein the optimization code is configured to cause at least one of the at least one processor to:
calculate a first semantic loss value based on similarities between the plurality of first global recovery features and the plurality of first global features;
calculate a second semantic loss value based on similarities between the plurality of second global recovery features and the plurality of second global features of the plurality of second modal data pieces;
obtain a first loss value by performing summation on the first semantic loss value and the second semantic loss value; and
optimize the feature extraction model based on the first loss value.

13. The model training apparatus according to claim 12, the optimization code is configured to cause at least one of the at least one processor to:
calculate a second loss value based on the plurality of first global features and the plurality of second global features;
obtain, by performing feature extraction, via the feature extraction model, on marked first modal data in the first modal data set and marked second modal data in the second modal data set, a third global feature of target first modal data and a fourth global feature of target second modal data, and calculating a third loss value based on the third global feature and the fourth global feature;
obtain a local recovery feature of the target first modal data, and calculating a fourth loss value based on the local recovery feature of the target first modal data; and
obtain a summation result by performing summation on the first loss value, the second loss value, the third loss value, and the fourth loss value, and optimizing the feature extraction model based on the summation result.

14. The model training apparatus according to claim 13, wherein the optimization code is configured to cause at least one of the at least one processor to:
calculate a third semantic loss value based on similarities between the plurality of first global features and the plurality of second global features;
calculate a fourth semantic loss value based on similarities between the plurality of second global features and the plurality of first global features; and
obtain the second loss value by performing summation on the third semantic loss value and the fourth semantic loss value.

15. The model training apparatus according to claim 13, wherein the optimization code is configured to cause at least one of the at least one processor to:
obtain a spliced feature by splicing the third global feature and the fourth global feature;
obtain a predicted matching relationship between the third global feature and the fourth global feature based on the spliced feature; and
calculate the third loss value based on the predicted matching relationship and a correspondence between the third global feature and the fourth global feature.

16. The model training apparatus according to claim 13, wherein the optimization code is configured to cause at least one of the at least one processor to obtain the local recovery feature after the feature extraction model performs feature extraction on masked target first modal data and the second modal data, and
wherein the optimization code is further configured to cause at least one of the at least one processor to:
predict masked first sub-modal data in the target first modal data based on the local recovery feature; and
calculate the fourth loss value based on predicted first sub-modal data and the masked first sub-modal data.

17. The model training apparatus according to claim 11, wherein the feature extraction model comprises a first encoder, a second encoder, and a third encoder, and
wherein the feature prediction code is configured to cause at least one of the at least one processor to:
encode a plurality of first masked data pieces in the first masked data set by using the first encoder, to obtain first feature information of the plurality of first masked data pieces;
encode the plurality of second modal data pieces in the second modal data set by using the second encoder, to obtain second feature information of the plurality of second modal data pieces; and
perform feature interaction on a first plurality of pieces of first feature information and a second plurality of pieces of second feature information by using the third encoder, to obtain the plurality of first global recovery features and the plurality of second global features.

18. The model training apparatus according to claim 17, wherein a fifth piece of first masked data in the first masked data set is represented as an i^{th} piece of first masked data, and the i^{th} piece of first masked data is obtained by masking an i^{th} piece of first modal data in the first modal data set,
wherein i^{th} first feature information of the i^{th} piece of first masked data is represented as an i^{th} piece of first feature information, the i^{th} piece of first feature information comprising a first i^{th} local feature and an i^{th} local recovery feature of the i^{th} piece of first modal data, and i being a positive integer less than or equal to a number of corresponding pieces of the plurality of first modal data pieces and the plurality of second modal data pieces,
wherein a sixth piece of second modal data in the second modal data set is represented as an i^{th} piece of second modal data, i^{th} second feature information of the i^{th} piece of second modal data is represented as an i^{th} piece of second feature information, and the i^{th} piece of second feature information comprises a second i^{th} local feature of the i^{th} piece of second modal data,
wherein the third encoder comprises a self-attention mechanism and a cross-attention mechanism, and
wherein the feature prediction code is configured to cause at least one of the at least one processor to:
mine an association relationship between a first plurality of features in a piece of first feature information by using the self-attention mechanism, an association relationship between features in the i^{th} piece of first feature information comprising an association relationship between a first plurality of local features of the i^{th} piece of first modal data, an association relationship between a first plurality of local recovery features of the i^{th} piece of first modal data, and an association relationship between a local feature and a local recovery feature of the i^{th} piece of first modal data;
mine an association relationship between a second plurality of features in the second feature information by using the self-attention mechanism, an association relationship between a third plurality of features in the i^{th} piece of second feature information comprising an association relationship between a second plurality of local features of the i^{th} piece of second modal data; and
perform, based on the cross-attention mechanism, feature interaction on a plurality of pieces of first feature information after mining and a plurality of pieces of second feature information.

19. The model training apparatus according to claim 17, wherein the feature extraction model comprises the first encoder, the second encoder, and the third encoder, and wherein the feature prediction code is configured to cause at least one of the at least one processor to:
encode the plurality of first modal data pieces via the first encoder, to obtain third feature information of the plurality of first modal data pieces;
encode the plurality of second masked data pieces via the second encoder, to obtain fourth feature information of the plurality of second masked data pieces; and
perform feature interaction on a third plurality of pieces of third feature information and a fourth plurality of pieces of fourth feature information via the third encoder, to obtain the plurality of first global features and the plurality of second global recovery features.

20. A non-transitory computer-readable storage medium, storing computer code which, when executed by at least one processor, causes the at least one processor to at least:
obtain a first modal data set and a second modal data set, wherein the first modal data set comprises a plurality of first modal data pieces, and a first piece of the plurality of first modal data pieces comprises a plurality of first sub-modal data pieces, wherein the second modal data set comprises a plurality of second modal data pieces, and a second piece of the plurality of second modal data pieces comprises a plurality of second sub-modal data pieces, and wherein the plurality of first modal data pieces correspond to the plurality of second modal data pieces; and
obtain a first masked data set by masking at least one third piece of the plurality of first sub-modal data pieces, and obtain a second masked data set by masking at least one fourth piece of the plurality of second sub-modal data pieces; and
perform feature prediction on the first masked data set and the second modal data set based on a feature extraction model, to obtain a plurality of first global recovery features of the plurality of first modal data pieces and a plurality of second global features of the plurality of second modal data pieces;
perform feature prediction on the second masked data set and the first modal data set based on the feature extraction model, to obtain a plurality of first global features of the plurality of first modal data pieces and a plurality of second global recovery features of the plurality of second modal data pieces; and
generate a trained feature extraction model for retrieving corresponding first modal data and second modal data by optimizing the feature extraction model based on the plurality of first global recovery features, the plurality of first global features, the plurality of first global recovery features, and the plurality of second global features.
